(19) United States
(12) Patent Application Publication
(10) Pub. No.: US 2022/0241733 A1
(43) Pub. Date: Aug. 4, 2022

(54) CARBON NANOTUBE/NANOFIBER CONDUCTIVE COMPOSITE MEMBRANE AND PREPARATION METHOD THEREOF

(71) Applicant: DALIAN UNIVERSITY OF TECHNOLOGY, Dalian, Liaoning (CN)

(72) Inventors: Xie QUAN, Dalian, Liaoning (CN); Lei DU, Dalian, Liaoning (CN); Shuo CHEN, Dalian, Liaoning (CN)

(21) Appl. No.: 17/623,816

(22) PCT Filed: Jul. 5, 2019
(86) PCT No.: PCT/CN2019/094863

§ 371 Date: Dec. 29, 2021

(51) Int. Cl. B01D 71/02; B01D 69/12; B01D 69/06; B01D 69/08; B01D 69/04; B01D 67/00

(52) U.S. Cl. CPC B01D 71/021; B01D 69/12; B01D 69/06; B01D 69/087; B01D 2323/39; B01D 67/0079; B01D 2323/12; B01D 2323/30; B01D 69/04

(57) ABSTRACT

The present invention belongs to the technical field of membranes and provides a carbon nanotube/nanofiber conductive composite membrane and a preparation method thereof. The conductive membrane with a meshy pore structure intertwined by one-dimensional nano materials is constructed by taking one-dimensional nanofiber nonwovens prepared by electrospinning as a support layer and CNTs cross linked on the support layer as a separation layer. The membrane pore size of the composite membrane involved can be controlled from microfiltration to ultrafiltration, and membrane morphology includes flat membranes, hollow fiber membranes, and spiral-wound membranes. The main advantages and beneficial effects of the composite membrane involved are: simple preparation steps, better permeability and mechanical strength, good hydrophilicity and electrical conductivity, and easy mass production and application.

### FIELD OF THE INVENTION

The present invention relates to a carbon nanotube/nanofiber conductive composite membrane and a preparation method thereof, and belongs to the technical field of membranes.

### BACKGROUND OF THE INVENTION

As an energy efficient and convenient phase separation technology, membrane separation has been widely used in advanced sewage treatment, drinking water purification and resource recycling in the field of water treatment. However, the traditional membrane separation suffers from the problems of the trade-off relationship between water permeability and separation ability, serious membrane fouling and single membrane function, which seriously restrict the further development and application of the membrane separation technology.

Studies have found that the separation membrane prepared based on carbon nanotubes (CNTs) presents a meshy membrane structure and interpenetrating membrane pores constructed by intertwined one-dimensional nanomaterial, which have the advantages of high porosity, low pore curvature and high permeability. Meanwhile, the excellent electrical conductivity of the CNTs makes it possible to effectively slow down the membrane fouling and alleviate the trade-off between membrane permeability and separation ability through electrical assistance (electrostatic repulsion, electrical enhanced adsorption and electrochemical oxidation)-membrane filtration coupling technology. Meanwhile, the electro-assistance is expected to endow CNTs membranes with new functions, which can effectively alleviate the problem faced by the membrane separation technology. At present, there are mainly three types of CNTs separation membranes: the first type is CNTs membranes assembled by pure CNTs; the second type is mixed matrix membrane prepared by homogeneous mixing of CNTs and other membrane materials (polymer materials, ceramic membrane materials and so on); and the third type is composite membrane prepared by coating the CNTs as a separation layer on a support layer matrix. However, the current CNT separation membranes have some problems that affect the performance and application of the above CNTs separation membranes. For example, pure CNTs membranes have the problems of high preparation cost, poor mechanical strength, and laborious application. The CNTs in mixed matrix CNT membranes are seriously coated by other membrane materials, which hinders the advantage of CNTs. The permeability of composite CNTs membranes is limited by the support layer matrix, and the structural advantages of CNTs as one-dimensional nanomaterials are restricted.

### SUMMARY OF THE INVENTION

Considering the great research and market prospects of CNTs separation membranes, the present invention mainly aims to provide a simple and efficient CNTs/nanofiber composite separation membrane easy for large-scale production to address the problems of the current CNTs separation membrane preparation technology. The membranes are prepared by coating crosslinked CNTs as the separation layer on the non-woven fabric support layer composed of one-dimensional nanofibers, so that the entire composite membrane retains a meshy pore structure formed by interweaving one-dimensional nanomaterials.

### The Technical Solution of the Present Invention

A carbon nanotube/nanofiber composite membrane is divided into a support layer and a functional layer; nanofibers prepared by electrospinning are used as the support layer and CNTs are used as the separation layer; the CNTs are coated on the surfaces of the nanofibers; the CNTs are fixed by crosslinking agent 1 and crosslinking agent 2; the CNTs and nanofibers are both one-dimensional linear materials, which can be used to construct a separation membrane with three-dimensional meshy pore structure; and the interaction between the support layer and the separation layer is enhanced by interlacing linear materials to form a stable membrane structure.

The support layer in the present invention can be made by synthetic polymer polymers, natural polymers, inorganic alkoxides and ceramic precursors, including but is not limited thereto, and materials which are suitable for electrospinning can be used to prepare the nanofiber support layer.

The crosslinking agent 1 and crosslinking agent 2 consist of polyacrylamide and succinic acid, or polyvinyl alcohol and glutaraldehyde, or polyvinyl alcohol and glutaric acid, or phenolic resin and oxalic acid.

The membrane morphology includes flat membranes, hollow fiber membranes, and spiral-wound membranes.

A preparation method of the carbon nanotube/nanofiber conductive composite membrane comprises steps as follows:

First Step: Preparation of Nanofiber Support Layer

(1) dissolving the spinning materials used as the support layer in corresponding solvent to form a spinning solution with a mass fraction of 10%-20%, and conducting electrospinning preparation; slowly injecting the spinning solution through a micro-injection pump; moving the droplets to a collector device under the electrostatic interaction and stretching into nanofibers; fitting the electrospinning voltage density to 1 kV/cm and the spinning distance to be in the range of 10 cm-20 cm; controlling the spinning time in the range of 4-20 h according to the concentration of spinning solution; and obtaining the corresponding nanofiber support layer from the collector device;

wherein according to the different membrane shapes, the specific operations are as follows:

flat membrane: a roller nanofiber collector or flat nanofiber collector is used to receive nanofibers prepared by electrospinning; and after the collection, the nanofibers are directly removed from the surface of the collector and set to hot-press forming flat support layer;

hollow fiber membrane: a dynamic continuous filiform collector is used to receive nanofibers prepared by electrospinning; in the process of electrospinning, the continuous filiform collector is controlled to pass through a nanofiber receiving area at a fixed rate, and then the filiform collector is transferred to a heating chamber; the prepared nanofibers are heated to shrink stably according to the heat resistance of materials; the filiform collector is immersed in a 0.1 mol/L dilute acid solution or copper salt solution for 5-60 minutes; and then the hollow fiber support layer is obtained by pulling out filiform collector;

spiral-wound membrane: a conductive spiral-wound hollow latticed collector is used as the nanofiber collector; after the collection, the nanofibers are set to hot-press together with the conductive spiral-wound hollow latticed collector; and then the non-woven nanofibers are fixed by glue sealing and then cooled to room temperature to obtain the spiral-wound membrane support layer.

second step: preparation of CNTs functional layer by electrostatic spraying

the CNTs acidified by mixed acids are dispersed in water to prepare a 5-10 mg/mL dispersion; the mixed acids are constituted by 95-98 wt. % concentrated sulfuric acid and 65-68 wt. % concentrated nitric acid with a volume ratio of 3:1; and then, the nanofiber support layer is electrostatically sprayed at a regulated voltage density of 1 kV/cm and a spinning distance in the range of 10-20 cm;

third step: crosslinking of carbon nanotube/nanofiber conductive composite membrane

the prepared composite membrane is taken off and immersed in the mixture of the cross-linking agent 1 and the cross-linking agent 2; 2M hydrochloric acid is added into the mixture solution to control pH to 2; and after taking the membrane out, the membrane is rinsed with deionized water and drilled and solidified at 60° C.

wherein according to the different membrane shapes, the specific operations are as follows:

flat membrane: a roller nanofiber collector or flat nanofiber collector is used to receive nanofibers prepared by electrospinning; and after the collection, the nanofibers are directly removed from the surface of the collector and set to hot-press forming flat support layer;

hollow fiber membrane: a dynamic continuous filiform collector is used to receive nanofibers prepared by electrospinning; in the process of electrospinning, the continuous filiform collector is controlled to pass through a nanofiber receiving area at a fixed rate, and then the filiform collector is transferred to a heating chamber; the prepared nanofibers are heated to shrink stably according to the heat resistance of materials; the filiform collector is immersed in a 0.1 mol/L dilute acid solution or copper salt solution for 5-60 minutes; and then the hollow fiber support layer is obtained by pulling out filiform collector;

spiral-wound membrane: a conductive spiral-wound hollow latticed collector is used as the nanofiber collector; after the collection, the nanofibers are set to hot-press together with the conductive spiral-wound hollow latticed collector; and then the non-woven nanofibers are fixed by glue sealing and then cooled to room temperature to obtain the spiral-wound membrane support layer.

second step: preparation of CNTs functional layer by electrostatic spraying

the CNTs acidified by mixed acids are dispersed in water to prepare a 5-10 mg/mL dispersion; the mixed acids are constituted by 95-98 wt. % concentrated sulfuric acid and 65-68 wt. % concentrated nitric acid with a volume ratio of 3:1; and then, the nanofiber support layer is electrostatically sprayed at a regulated voltage density of 1 kV/cm and a spinning distance in the range of 10-20 cm;

third step: crosslinking of carbon nanotube/nanofiber conductive composite membrane

the prepared composite membrane is taken off and immersed in the mixture of the cross-linking agent 1 and the cross-linking agent 2; 2M hydrochloric acid is added into the mixture solution to control pH to 2; and after taking the membrane out, the membrane is rinsed with deionized water and drilled and solidified at 60° C.

The present invention has the beneficial effects:

(1) The separation membrane constructed based on full one-dimensional nanomaterials has the advantages of a meshy interconnected hole structure, such as high membrane porosity, low pore tortuosity, and high effective porosity. These advantages enhance the membrane permeability. The flux of the present invention is 2-10 times higher than the commercial separation membrane with same pore size.

(2) The separation membrane of the present invention exhibits excellent flexibility and mechanical strength due to assembly construction based on one-dimensional nanomaterials with an ultrahigh aspect ratio.

(3) The interface between the separation layer and the support layer is made up of two kinds of intertwined one-dimensional linear nanomaterials, which enhances the interaction between the support layer and the separation layer and plays a role in stabilizing the overall membrane structure.

(4) The CNTs separation layer is prepared by the electrostatic spraying process, resulting in the separation layer with a porosity of more than 80%, which is beneficial to reduce mass transfer resistance and improve membrane permeability.

(5) The conductivity of CNTs in the separation layer is retained, which is beneficial to coupling with other technologies.

(6) A cross-linking agent is used to fix the CNTs to ensure the stability of the separation layer.

(7) The method is flexible and controllable, and can be used to prepare separation membranes with various shapes. Furthermore, the method is easy for large-scale production and application.

### DESCRIPTION OF THE DRAWINGS

FIG. 1 is the scanning electron microscope image of a support layer of a carbon nanotube/nanofiber conductive composite membrane; and

FIG. 2 is the scanning electron microscope image of a separation layer of a carbon nanotube/nanofiber conductive composite membrane.

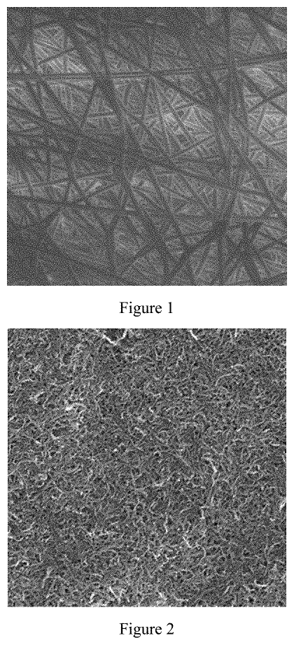

### DETAILED DESCRIPTION

Embodiments of the present invention will be described below in combination with the drawings, but the present invention is not limited to the following embodiments.

### Embodiment 1. Preparation of CNTs/Polyacrylonitrile (PAN) Nanofiber Composite Flat Membranes

The First Step: Preparation of Nanofiber Matrix by Electrospinning

The polymer PAN used as a support layer is dissolved in N, N-dimethylformamide(DMF) to form a spinning solution with a mass fraction of 15%. The electrospinning voltage density is fit to around 1 kV/cm and the spinning distance is in the range of 10-20 cm. The spinning time is controlled at 10 h according to the concentration. The corresponding nanofiber matrix is obtained from the collector and set to hot-press at 150° C. to obtain a flat nanofiber support layer.

The Second Step: Preparation of CNTs Functional Layer by Electrostatic Spraying

The CNTs with diameter of 60-100 nm acidified by mixed acids are dispersed in water to prepare a 5 mg/mL dispersion. Then, then nanofiber matrix is electrostatically sprayed for 6 h at the controlled voltage density of around 1 kV/cm and the spinning distance in the range of 10-20 cm.

The Third Step: Crosslinking of CNTs/PAN Nanofiber Composite Membranes

The prepared composite membrane is taken off and immersed in the mixture of (0.2%)polyacrylamide and (1%)oxalic acid for 1 h. 2M hydrochloric acid is added into the mixture solution to control pH to be acidic. After taking the membrane out, the membrane is rinsed with deionized water and dried and solidified at 60° C.

Results: the support layer and the separation layer of the prepared CNTs/PAN nanofiber composite flat membranes both show a meshy interconnected hole structure. The pore size of the support layer is in the range of 1-2 μm and the pore size of the separation layer is around 300 nm. Because PAN has good thermal stability, which is convenient for shrinking nanofibers at higher temperatures CNTs/nanofiber composite membranes made of PAN materials show optimal mechanical strength and stability.

### Embodiment 2. Preparation of CNTs/PAN Nanofiber Composite Hollow Fiber Membranes

The First Step: Preparation of Nanofiber Matrix by Electrospinning

The polymer PAN used as the matrix is dissolved in DMF to forma spinning solution with a mass fraction of 15%. The electrospinning voltage density is controlled to around 1 kV/cm and the spinning distance is in the range of 10 cm. A stainless steel wire collector is used as a receiving apparatus. The spinning time is controlled at 6 h according to the concentration. Then, the corresponding nanofiber hollow fiber support layer is obtained from the receiving apparatus.

The Second Step: Preparation of CNTs Functional Layer by Electrostatic Spraying

The 60-100 nm CNTs acidified by mixed acids are dispersed in water to prepare a 5-10 mg/mL dispersion. Then, then a no fiber matrix is electrostatically sprayed for 6 h at the controlled voltage density of around 1 kV/cm and the spinning distance in the range of 10-20 cm.

The Third Step: Crosslinking of CNTs/PAN Nanofiber Composite Membranes

The prepared composite membrane is taken off with the collector and immersed in the mixture of (0.2%)polyvinyl alcohol and (1%) glutaric acid for 1 h. 2M hydrochloric acid is added into the mixture solution to control pH to be acidic. After taking the membrane out, the membrane is rinsed with deionized water and dried and solidified at 60° C. Then, the composite membrane with collector is preoxidized at 250° C. in the oven. After pre oxidation, the composite membrane is immersed in the 1M copper sulfate solution for 10 min together with collector. The hollow fiber membrane can be pulled out from a filiform collector. The CNTs/PAN nanofiber conductive composite membrane is obtained after cleaning by deionized water and drying.

Results: the support layer and the separation layer of the prepared CNTs/PAN nanofiber composite flat membranes both show a meshy interconnected hole structure. The pore size of the support layer is in the range of 1-2 μm and the pore size of the separation layer is around 300 nm.

### Embodiment 3. Preparation of CNTs/Polyvinylidene Fluoride(PVDF) Nanofiber Composite Flat Membranes

The First Step: Preparation of Nanofiber Support Layer by Electrospinning

The polymer PVDF used as the matrix is dissolved in the mixture of DMF and acetone (volume ratio 9:1) to form a spinning solution with a mass fraction of 18%. The electrospinning voltage density is fit to around 1 kV/cm and the spinning distance is in the range of 10 cm. The spinning time is controlled at 10 h according to the concentration. Then, the nanofibers are directly removed from the collector and set to hot-press at 80° C. to form a flat nanofiber matrix.

The Second Step: Preparation of CNTs Functional Layer by Electrostatic Spraying

The 10-20 nm CNTs acidified by mixed acids are dispersed in water to prepare a 5-10 mg/mL dispersion. Then, then nanofiber matrix is electrostatically sprayed for 6 h at the controlled voltage density of around 1 kV/cm and the spinning distance in the range of 10-20 cm.

The Third Step: Crosslinking of CNTs/PVDF Nanofiber Composite Membranes

The prepared composite membrane is taken off and immersed in the ethanol solution with (0.2%)phenolic resin for 1 h. Then, oxalic acid is added into the mixture solution to control pH to be acidic. After taking the membrane out, the membrane is rinsed with ethanol and dried and solidified at 60° C.

Results: the support layer and the separation layer of prepared CNTs/PVDF nanofiber composite flat membranes both show a meshy interconnected hole structure. The pore size of the support layer is in the range of 400-600 nm and the pore size of the separation layer is around 70 nm.

### Embodiment 4. Preparation of CNTs/Aluminium Oxide (AO) Nanofiber Composite Flat Membranes

The First Step: Preparation of Nanofiber Support Layer by Electrospinning

The formic acid and the acetic acid are added to high-purity water at a mass ratio of 1:1, and then a certain amount of Al powder is added into the mixture solution with heating and stirring until Al powder is completely dissolved. A glass fiber membrane is used to filter the above solution to remove the residue. The solution is prepared into Al gels with a mass fraction of about 10% and a certain amount of polyvinylpyrrolidone is added to increase the viscosity of the solution. The electrospinning voltage density is fit to around 1 kV/cm and the spinning distance is in the range of 10 cm. The spinning time is controlled at 10 h according to the concentration. Then, the nanofibers are directly removed from the collector and calcined at 800° C. The Al₂O₃ nanofiber matrix is obtained after preserving the temperature for 2 h.

The Second Step: Preparation of CNTs Functional Layer by Electrostatic Spraying

The 60-100 nm CNTs acidified by mixed acids are dispersed in water to prepare a 5-10 mg/mL dispersion. Then, the voltage density is fit to around 1 kV/cm. The Al₂O₃ nanofiber substrate after calcination is fixed on the receiving apparatus and the spinning distance is in the range of 10-20 cm to electrostatically spray then nanofiber matrix for 6 h.

The Third Step: Crosslinking of CNTs/Nanofiber Composite Membrane

The prepared composite membrane is taken off and immersed in the ethanol solution with (0.2%)phenolic resin for 1 h. Then, oxalic acid is added into the mixture solution to control pH to be acidic. After taking the membrane out, the membrane is rinsed with ethanol and dried and solidified at 60° C.

Results: the support layer and the separation layer of prepared CNTs/AO nanofiber composite flat membranes both show a network-like interconnected hole structure. The pore size of the support layer is in the range of 300-500 nm and the pore size of the composite membrane is around 100 nm.

### Embodiment 5. Preparation of CNTs/PAN Nanofiber Composite Spiral-Wound Membrane

The First Step: Preparation of Nanofiber Matrix by Electrospinning

The polymer PAN used as the matrix is dissolved in DMF to form a spinning solution with a mass fraction of 15%. The electrospinning voltage density is fit to around 1 kV/cm and the spinning distance is in the range of 10-20 cm. The spinning time is controlled at 10 h according to the concentration. The spiral-wound stainless steelreseau is used as a collector. After the spinning, the non-woven membrane is fixed by gluing and hot pressing, and then cooled to room temperature to obtain the corresponding spiral-wound nanofiber support layer.

The Second Step: Preparation of CNTs Functional Layer by Electrostatic Spraying

The 60-100 nm CNTs acidified by mixed acids are dispersed in water to prepare a 5 mg/mL dispersion. Then, then nanofiber matrix is electrostatically sprayed for 6 h at the controlled voltage density of around 1 kV/cm and the spinning distance in the range of 10-20 cm.

The Third Step: Crosslinking of CNTs/PAN Nanofiber Composite Membranes

The prepared composite membrane is taken off and immersed in the mixture of (0.2%)polyacrylamide and (1%)oxalic acid for 1 h. 2M hydrochloric acid is added into the mixture solution to control pH to be acidic. After taking the membrane out, the membrane is rinsed with deionized water and dried and solidified at 60° C.

Results: the prepared CNTs/PAN nanofiber composite spiral-wound membrane shows a meshy interconnected hole structure. The pore size of the composite membrane is around 300 nm.

1. A carbon nanotube/nanofiber composite membrane, wherein the CNT/nanofiber composite separation membrane is divided into a support layer and a functional layer; nanofibers prepared by electrospinning are used as the support layer and CNTs are used as the separation layer; the CNTs are coated on the surfaces of the nanofibers; the CNTs are fixed by crosslinking agent 1 and crosslinking agent 2; the CNTs and nanofibers are both one-dimensional linear materials, which can be used to construct a separation membrane with three-dimensional meshy pore structure; and the interaction between the support layer and the separation layer is enhanced by interlacing linear materials to form a stable membrane structure.

2. The carbon nanotube/nanofiber composite membrane according to claim 1, wherein the crosslinking agent 1 and crosslinking agent 2 consist of polyacrylamide and succinic acid, or polyvinyl alcohol and glutaraldehyde, or polyvinyl alcohol and glutaric acid, or phenolic resin and oxalic acid.

3. The carbon nanotube/nanofiber composite membrane according to claim 1, wherein the morphology of the carbon nanotube/nanofiber composite membrane comprises flat membranes, hollow fiber membranes, and spiral-wound membranes.

4. A preparation method of the carbon nanotube/nanofiber composite membrane, comprising steps as follows:
first step: preparation of nanofiber support layer
(1) dissolving the spinning materials used as the support layer in corresponding solvent to form a spinning solution with a mass fraction of 10%-20%, and conducting electrospinning preparation; slowly injecting the spinning solution through a micro-injection pump; moving the droplets to a collector device under the electrostatic interaction and stretching into nanofibers; fitting the electrospinning voltage density to 1 kV/cm and the spinning distance to be in the range of 10 cm-20 cm; controlling the spinning time in the range of 4-20 h according to the concentration of spinning solution; and obtaining the corresponding nanofiber support layer from the collector device;
wherein according to the different membrane shapes, the specific operations are as follows:
flat membrane: a roller nanofiber collector or flat nanofiber collector is used to receive nanofibers prepared by electrospinning; and after the collection, the nanofibers are directly removed from the surface of the collector and set to hot-press forming flat support layer;
hollow fiber membrane: a dynamic continuous filiform collector is used to receive nanofibers prepared by electrospinning; in the process of electrospinning, the continuous filiform collector is controlled to pass through a nanofiber receiving area at a fixed rate, and then the filiform collector is transferred to a heating chamber; the prepared nanofibers are heated to shrink stably according to the heat resistance of materials; the filiform collector is immersed in a 0.1 mol/L dilute acid solution or copper salt solution for 5-60 minutes; and then the hollow fiber support layer is obtained by pulling out filiform collector;
spiral-wound membrane: a conductive spiral-wound hollow latticed collector is used as the nanofiber collector; after the collection, the nanofibers are set to hot-press together with the conductive spiral-wound hollow latticed collector; and then the non-woven nanofibers are fixed by glue sealing and then cooled to room temperature to obtain the spiral-wound membrane support layer.
second step: preparation of CNTs functional layer by electrostatic spraying
the CNTs acidified by mixed acids are dispersed in water to prepare a 5-10 mg/mL dispersion; the mixed acids are constituted by 95-98 wt. % concentrated sulfuric acid and 65-68 wt. % concentrated nitric acid with a volume ratio of 3:1; and then, the nanofiber support layer is electrostatically sprayed at a regulated voltage density of 1 kV/cm and a spinning distance in the range of 10-20 cm;
third step: crosslinking of carbon nanotube/nanofiber conductive composite membrane
the prepared composite membrane is taken off and immersed in the mixture of the cross-linking agent 1 and the cross-linking agent 2; 2M hydrochloric acid is added into the mixture solution to control pH to 2; and after taking the membrane out, the membrane is rinsed with deionized water and drilled and solidified at 60° C.

5. The carbon nanotube/nanofiber composite membrane according to claim 2, wherein the morphology of the carbon nanotube/nanofiber composite membrane comprises flat membranes, hollow fiber membranes, and spiral-wound membranes.
